(19) United States
(12) Patent Application Publication
(10) Pub. No.: US 2016/0306623 A1
(43) Pub. Date: Oct. 20, 2016

(54) CONTROL MODULE OF NODE AND FIRMWARE UPDATING METHOD FOR THE CONTROL MODULE

(71) Applicant: AIC INC., Taoyuan Hsien (TW)

(72) Inventors: Yu-Heng Su, Taoyuan Hsien (TW); Wen-Hua Shen, Taoyuan Hsien (TW); Shih-Chieh Hsu, Taoyuan Hsien (TW)

(21) Appl. No.: 14/688,165

(22) Filed: Apr. 16, 2015

(51) Int. Cl. G06F 9/445; G06F 9/44; G06F 13/40

(52) U.S. Cl. CPC G06F 8/66; G06F 13/4022; G06F 9/4401

(57) ABSTRACT

A control module of a node comprising a baseboard management controller (BMC), a first memory and a second memory is present. The first memory stores a working firmware, the second memory stores a default firmware. The BMC normally connects with the first memory and reads the working firmware to boot during a booting procedure. If the BMC cannot boot through executing the working firmware after a firmware updating procedure executed for updating the working firmware failed, it switches to connect with the second memory and reads the default firmware to replace with the working firmware to boot. After the BMC boots through the default firmware successfully, it switches back to connect with the first memory, and re-updates the working firmware again.

### BACKGROUND OF THE INVENTION

1. Field of the Invention

The invention relates to a node, and inparticularly to a control module of the node, and a firmware updating method for the control module.

2. Description of Prior Art

Generally, each node (such as a server node) arranged in a rack respectively comprises a baseboard management controller (BMC), and the nodes respectively use the BMCs to control and maintain themselves.

The above mentioned BMC is a kind of system on chip (SoC), which comprises memories therein and operates through executing an internal firmware. As such, the BMC is the same as the central processing unit (CPU) of the node, which needs to update the internal firmware some times.

In a regular procedure, the BMC updates the internal firmware automatically and directly when receiving an updating firmware. However, if an updating procedure for updating the internal firmware by the updating firmware is interrupted (for example, the node crashes or the power of the rack is cut off) accidentally during execution, or the updating firmware is a wrong updating file for updating the internal firmware, it may cause the updating procedure to fail and the BMC will not be able to reboot successfully after the updating procedure.

According to above descriptions, if the BMC does not have any support from an operating system (OS) of the node or a system interface, it cannot re-update the internal firmware which fails to updat again, and will not normally operate anymore.

As such, how to rescue the BMC from the updating failure procedure and to boot the BMC normally without any external support, and re-update the failed firmware again, is worth for the skilled in the art to research for.

### SUMMARY OF THE INVENTION

The object of the present invention is to provide a control module of a node, and a firmware updating method for the control module, which can make a BMC of the node to boot normally after executing a failed updating procedure, and can re-update the firmware which is updated failed again.

According to the above object, the present invention discloses a control module of the node which comprises a baseboard management controller (BMC), a first memory and a second memory. The first memory stores a working firmware, the second memory stores a default firmware. The BMC normally connects with the first memory and reads the working firmware to boot during a booting procedure. If the BMC cannot boot through executing the working firmware after a firmware updating procedure executed for updating the working firmware failed, it switches to connect with the second memory and reads the default firmware to replace with the working firmware to boot. After the BMC boots through the default firmware successfully, it switches back to connect with the first memory, and re-updates the working firmware again.

Comparing with related art, the present invention arranges the second memory and uses the default firmware of the second memory to boot for the BMC when the BMC fails to update the working firmware of the first memory. Therefore, the BMC can re-update the working firmware which is updated failed over and over again after booting normally through the default firmware, until the firmware updating procedure of the working firmware is successful.

According to the technical solution of the present invention, the problem that the BMC cannot boot normally after the internal firmware is updated failed is solved.

### BRIEF DESCRIPTION OF THE DRAWINGS

FIG. 1 is a schematic view of a rack of a first embodiment according to the present invention.

FIG. 2 is a connection diagram of a first embodiment according to the present invention.

FIG. 3 is a block diagram of a control module of a first embodiment according to the present invention.

FIG. 4 is a block diagram of a control module of a second embodiment according to the present invention.

FIG. 5 is a firmware updating flowchart of a first embodiment according to the present invention.

### DETAILED DESCRIPTION OF THE INVENTION

In cooperation with the attached drawings, the technical contents and detailed description of the present invention are described thereinafter according to a preferable embodiment, being not used to limit its executing scope. Any equivalent variation and modification made according to appended claims is all covered by the claims claimed by the present invention.

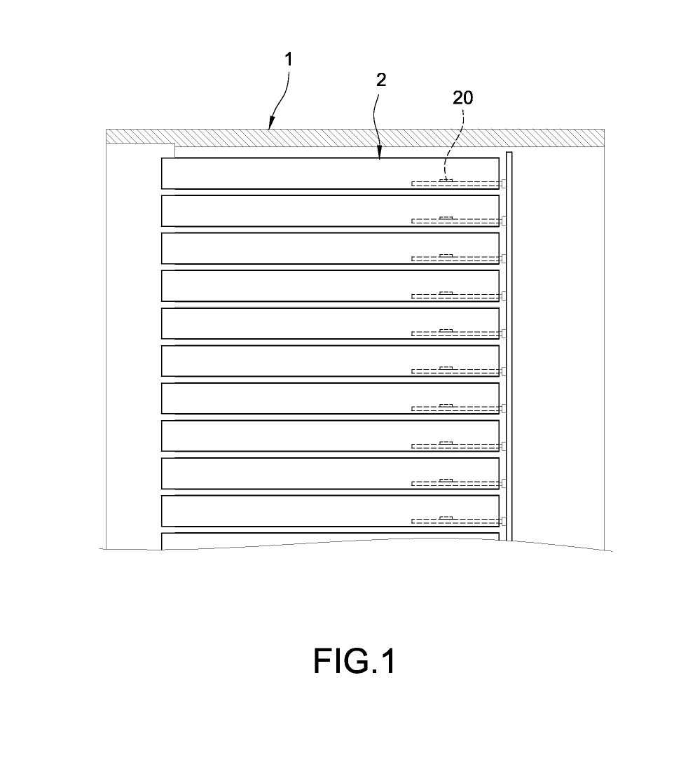

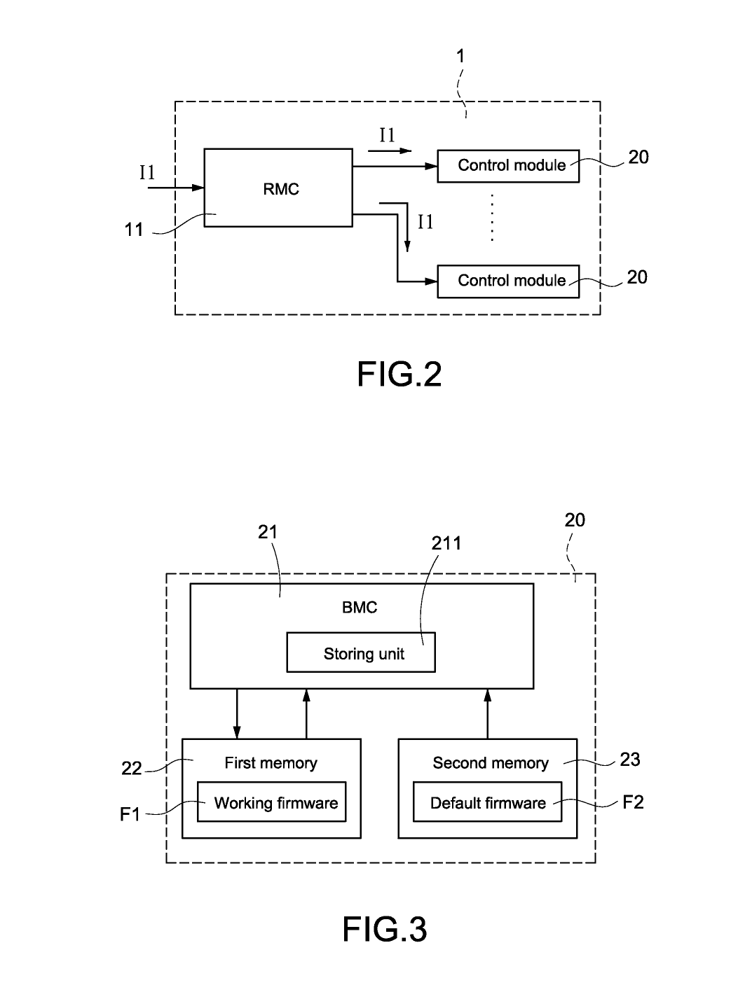

Refers to FIG. 1 and FIG. 2, FIG. 1 is a schematic view of a rack of a first embodiment according to the present invention, and FIG. 2 is a connection diagram of a first embodiment according to the present invention. The embodiment in FIG. 1 discloses a rack 1, which has a plurality of slots for respectively arranging a plurality of nodes 2. The rack 1 also comprises a rack management controller (RMC) 11 as shown in FIG. 2. Each of the plurality of nodes 2 respectively comprises a control module 20. The RMC 11 communicates with the control modules 20 respectively, so as to control the nodes 2, collect information from the nodes 2 and transmit data needed by the nodes 2 respectively through the control modules 20. In particularly, the nodes 2 in this embodiment are standard rack servers or just a bunch of disks nodes (JBOD nodes), not limited thereto.

In this embodiment, the RMC 11 communicates with the plurality of control modules 20 through physical or wireless transmission channels, such as intelligent platform management bus (IPMB), universal asynchronous receiver/transmitter (UART), inter-integrated circuit (I²C), serial pheripheral interface (SPI) or local area network (LAN), but not limited thereto.

The RMC 11 communicates with the control modules 20 of all nodes 2 in the rack 1 respectively through above mentioned transmission channel. In particularly, each of the plurality of control modules 20 respectively comprises a baseboard management controller (BMC) 21 as shown in FIG. 3, and the RMC 11 mainly communicates with the BMCs 21 of the nodes 2.

As shown in FIG. 2, if the control modules 20 need to update their internal firmware, the RMC 11 receives an updating firmware I1 in advance through a wired way or a wireless way. The updating firmware I1 here is an image of an updated version of the internal firmware, but not limited thereto.

In this invention, the RMC 11 transmits the updating firmware I1 to the BMCs 21 of the control modules 20 respectively through the transmission channel directly and immediately after receiving the updating firmware I1, so as to make each of the plurality of BMCs 21 to execute a firmware updating procedure according to the updating firmware I1. However, in other embodiments, the RMC 11 can follow a preset schedule, and transmits the updating firmware I1 to the BMCs 21 respectively when an updating time recorded in the preset schedule arrives.

FIG. 3 is a block diagram of a control module of a first embodiment according to the present invention. As shown in FIG. 3, the control module 20 in the present invention mainly comprises the BMC 21, a first memory 22 and a second memory 23, wherein the BMC 21 is electrically connected with the first memory 22 and the second memory 23 separately. More specifically, a connection between the BMC 21 and the first memory 22 is bidirectional, and a connection between the BMC 21 and the second memory 23 is unidirectional (detailed described below).

The BMC 21 comprises a storing unit 211, which is accomplished by random access memory (RAM), read only memory (ROM) or flash memory, but not limited thereto. If the BMC 21 receives the updating firmware I1 transmitted from the RMC 11, it temporarily stores the received updating firmware I1 to the storing unit 211 for a following firmware updating procedure.

The first memory 22 is a main memory of the BMC 21, and the first memory 22 records a working firmware F1 therein. In a normal status, the BMC 21 reads the working firmware F1 of the first memory 22, and executes the working firmware F1 for completing a booting procedure. In this embodiment, when executing the above mentioned firmware updating procedure, the BMC 21 updates the working firmwares F1 of the first memory 22 through the updating firmware I1.

The second memory 23 is a replicated memory of the BMC 21, and the second memory 23 records a default firmware F2 therein. In this embodiment, both the first memory 22 and the second memory 23 are ROM.

The main technical characteristic of the present invention is, in normal status, the BMC 21 only boots through reading and executing the working firmware F1 instead of through the default firmware F2. Also, the BMC 21 only updates the working firmware F1 instead of through the default firmware F2. The object of the above characteristic is to keep the completeness of the default firmware F2, and prevent the deafult firmware F2 from being damaged during an interrupted updating procedure and cannot be read and used by the BMC 21.

After being turned on, the BMC 21 is preset to read the working firmware F1 of the first memory 22 and executes the booting procedure through the working firmware F1. If the firmware updating procedure is needed, the BMC 21 writes the updating firmware I1 temporarily stored in the storing unit 211 to the first memory 22, and updates the working firmware F1 through the updating firmware I1. In this embodiment, if the firmware updating procedure is executed successfully, the second memory 23 will not be read and used by the BMC 21.

However, if the firmware updating procedure for updating the working firmware F1 fails (for example, the firmware updating procedure is interrupted before it is executed completely, or a wrong firmware is wrote to the first memory 22), the BMC 21 may not read the working firmware F1 of the first memory 22 after being reset. In other words, if the firmware updating procedure fails, the BMC 21 cannot execute the booting procedure successfully through the working firmware F1 anymore.

In the present invention, if the above situation occurs, the BMC 21 switches its connection to connect with the replicated second memory 23, reads the default firmware F2 of the second memory 23, and executes the booting procedure through the default firmware F2. In this embodiment, the default firmware F2 does not receive any updating procedure before, and is absolutely available for the BMC 21 to read and use.

It indicates the working firmware F1 of the first memory 22 fails and cannot be read if the BMC 21 boots through the second memory 23. As such, after the booting procedure is executed successful, the BMC 21 then switches the connection back to the first memory 22 upon the boot status, and executes the firmware updating procedure for updating the working firmware F1 of the first memory 22 again.

If the re-executed firmware updating procedure fails again, the BMC 21 can still boot through the default firmware F2 of the second memory 23 after being reset again, and then updates the working firmware F1 of the first memory 22 after booting completely, until the firmware updating procedure is successful and the working firmware F1 is updated.

If the re-executed firmware updating procedure is successful, then the BMC 21 switches the connection back to the first memory 22 after being reset, and then executes the booting procedure through the successful updated working firmware F1.

Generally speaking, if the BMC 21 boots through the first memory 22, it is only permitted to update the first memory 22. Also, if the BMC 21 boots through the second memory 23, it is only permitted to update the second memory 23, too. For solving above problem, and making the BMC 21 to update the first memory 22 after booting through the second memory 23, the control module 20 in the present invention further comprises a switch function configured to switch the connection between the BMC 21 and the memories 22 and 23.

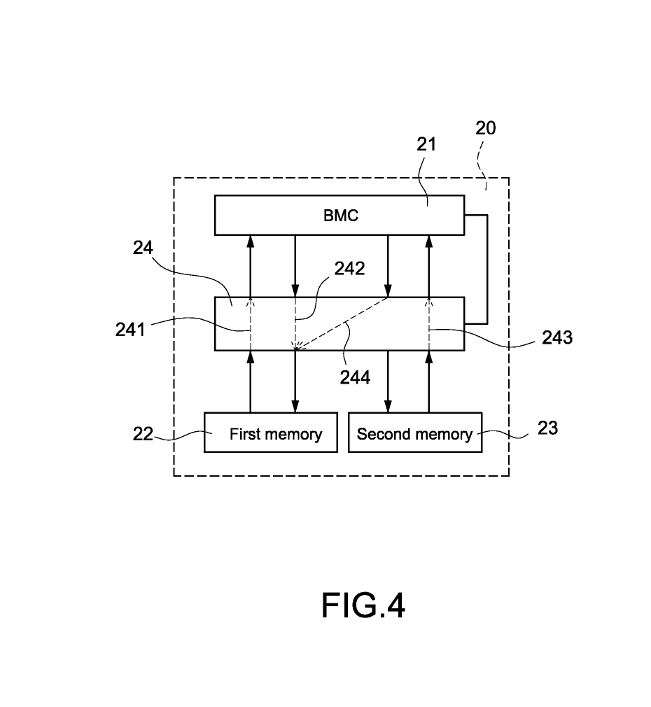

FIG. 4 is a block diagram of a control module of a second embodiment according to the present invention. In this embodiment, the control module 20 further comprises a hardware switch 24, the BMC 21 is electrically connected to the first memory 22 through the hardware switch 24, and electrically connected to the second memory 23 through the hardware switch 24. More specifically, the hardware switch 24 comprises a first reading channel 241 and a first writing channel 242 which are electrically connected to the BMC 21 and the first memory 22, and comprises a second reading channel 243 and a second writing channel 244 which are electrically connected to the BMC 21 and the second memory 23.

When executing the booting procedure, the BMC 21 reads the working firmware F1 of the first memory 22 through the first reading channel 241. When executing the firmware updating procedure, the BMC 21 writes the updating firmware I1 to the first memory 22 for updating the working firmware F1 through the first writing channel 242. It should be mentioned that the first reading channel 241 and the first writing channel 242 can be integrated into a single bidirectional transmission channel, but not intended to limit the scope of the present invention.

In this embodiment, the control module 20 is configured to execute a monitoring function through hardware or software (not shown). When determining the BMC 21 cannot boot through the working firmware F1 after being reset by the monitoring function, the control module 20 controls the BMC 21 to switch its connection so it can read the default firmware F2 of the second memory 23 through the second reading channel 243 and execute the booting procedure through the deafult firmware F2.

As shown in FIG. 4, the BMC 21 is configured to connect one pin of the hardware switch 24 (such as a switching pin) through a general purpose I/O (GPIO) interface 3. After the BMC 21 boots completely through the default firmware F2 of the second memory 23, the BMC 21 sends a control signal to the hardware switch 24 through the GPIO interface 3. Therefore, the hardware switch 24 switches the second writing channel 244 from connecting to the second memory 23 to connecting to the first memory 22 according to the control signal.

As such, the BMC 21 in the present invention does not execute any updating action to the second memory 23 through the second writing channel 244, so the connection between the BMC 21 and the second memory 23 is regarded as unidirectional. It should be mentioned that the second reading channel 243 and the second writing channel 244 can also be integrated into a single bidirectional transmission channel, but not intended to limit the scope of the present invention.

As described above, when executing the firmware updating procedure to the second memory 23, the BMC 21 should update the second memory 23, but through the switched connection of the second writing channel 244 of the hardware switch 24, however, the BMC 21 actually updates the first memory 22 during the firmware updating procedure. Therefore, the present invention overcomes the limitation of the related art that the BMC 21 can only update the memory which is used to boot in advance.

With the technical solution of the present invention, the BMC 21 can boot through the default firmware F2 of the second memory 23 after the working firmware F1 of the first memory 22 fails to update, therefore, the problem that the BMC 21 cannot boot normally after the firmware fails to update is solved. Besides, no matter the BMC 21 boots through the working firmware F1 of the first memory 22 or the default firmware F2 of the second memory 23, it only update the first memory 22 during the firmware updating procedure, therefore, the problem that the both firmwares of the first memory 22 and the second memory 23 fail to update and the BMC 21 cannot boot anyway will not occur. It should be mentioned that the specification of the present invention takes the first memory 22 and the second memory 23 for example, but in other embodiments, the control module 20 can be configured to arrange more than two memories, it is to say, the amount of the memories of the control module 20 is not limited in two.

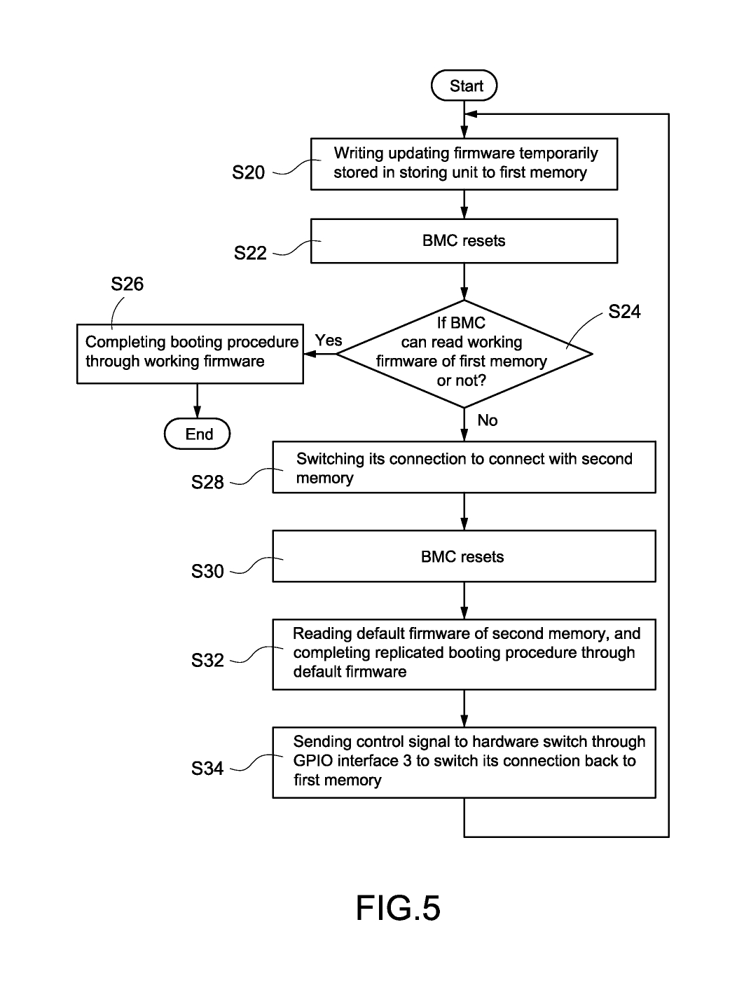

FIG. 5 is a firmware updating flowchart of a first embodiment according to the present invention. As shown in FIG. 5, if the control module 20 needs to update its firmware, the BMC 21 firstly writes the updating firmware I1 temporarily stored in the storing unit 211 to the first memory 22 (step S20) for updating the working firmware F1 of the first memory 22. More specifically, the BMC 21 updates the working firmware F1 of the first memory 22 through the first writing channel 242 of the hardware switch 24.

After step S20, the BMC 21 is then reset (step S22).

After being turned on again, the BMC 21 determines if it can read the working firmware F1 of the first memory 22 normally or not (step S24). In particularly, the BMC 21 reads the first memory 22 through the first reading channel 241 of the hardware switch 24.

If the BMC 21 reads the first memory 22 successfully, the BMC 21 then directly reads the working firmware F1 of the first memory 22, and completes the booting procedure through executing the working firmware F1 (step S26). In this embodiment, the working firmware F1 is updated successfully in above step S20.

However, if the BMC 21 cannot read the working firmware F1 of the first memory 22 in step S24, it means that the firmware updating procedure for updating the working firmware F1 fails. In this case, the BMC 21 switches its connection to connect with the second memory 23 (step S28). In particularly, the BMC 21 connects with the second memory 23 through the second reading channel 243 of the hardware switch 24.

After step S28, the BMC 21 is reset again (step S30). After being turned on again, the BMC 21 reads the default firmware F2 of the second memory 23 through the second reading channel 243, and completes a replicated booting procedure through executing the default firmware F2 (step S32). In some embodiments, the BMC 21 can skip step S30, and switches the connection to read the default firmware F2 of the second memory 23 directly and immediately after the reading for the first memory 22 is failed. However, which embodiment is applied to the BMC 21 depends on the internal settings of the BMC 21, not limited thereto.

After completing the replicated booting procedure through executing the default firmware F2, the BMC 21 sends the control signal to the hardware switch 24 through the GPIO interface 3 to switch its connection back to the first memory 22 (step S34). In particularly, the hardware switch 24 switches the second writing channel 244 connected to the second memory 23 to connect to the first memory 22 according to the control signal. After step S34, the BMC 21 returns to step S20 and re-execute the firmware updating procedure for updating the working firmware F1, until the working firmware F1 is updated successfully (i.e., until step S26 is executed).

As the skilled person will appreciate, various changes and modifications can be made to the described embodiment. It is intended to include all such variations, modifications and equivalents which fall within the scope of the present invention, as defined in the accompanying claims.

What is claimed is:

1. A control module (20) of a node (2), comprising:
a baseboard management controller (BMC,21) connected to a rack management controller (RMC,11) of a rack (1), wherein the node (2) is arranged in the rack (1);
a first memory (22) electrically connected to the BMC (21), having a working firmware (F1), the BMC (21) reading the working firmware (F1) to execute a booting procedure, and executing a firmware updating procedure for updating the working firmware (F1); and
a second memory (23) electrically connected to the BMC (21), having a default firmware (F2), the BMC (21) reading the default firmware (F2) to execute the booting procedure if the working firmware (F1) fails to update and the BMC (21) cannot boot through the working firmware (F1);
wherein, the BMC (21) switches to connect to the first memory (22) and re-executes the firmware updating procedure for updating the working firmware (F1) after completing the booting procedure through the default firmware (F2).

2. The control module (20) of claim 1, wherein both the first memory (22) and the second memory (23) are ROM.

3. The control module (20) of claim 2, wherein the BMC (21) comprises a storing unit (211) temporarily stored an updating firmware (I1), and the firmware updating procedure is to write the updating firmware (I1) to the first memory (22) for updating the working firmware (F1).

4. The control module (20) of claim 2, wherein further comprises a hardware switch (24), the hardware switch (24) comprises a first reading channel (241) and a first writing channel (242) connected to the BMC (21) and the first memory (22), and comprises a second reading channel (243) and a second writing channel (244) connected to the BMC (21) and the second memory (23), wherein the BMC (21) connects to a switching pin of the hardware switch (24) through a GPIO interface (3).

5. The control module (20) of claim 4, wherein the BMC (21) reads the working firmware (F1) to execute the booting procedure through the first reading channel (241), writes the updating firmware (I1) to the first memory (22) for updating the working firmware (F1) through the first writing channel (242) after booting through the working firmware (F1), and reads the default firmware (F2) to execute the booting procedure through the second reading channel (243) if the BMC (21) cannot boot through the working firmware (F1).

6. The control module (20) of claim 5, wherein the BMC (21) sends a control signal to the hardware switch (24) through the GPIO interface (3) after booting through the default firmware (F2), the hardware switch (24) switches the second writing channel (244) from connecting to the second memory (23) to connecting to the first memory (22) according to the control signal, and the BMC (21) writes the updating firmware (I1) to the first memory (22) for updating the working firmware (F1) through the second writing channel (244).

7. A firmware updating method for the control module (20) in claim 1, comprising:
a) determining if the BMC (21) can read the working firmware (F1) of the first memory (22) or not;
b) executing the booting procedure through the working firmware (F1) if the BMC (21) can read the working firmware (F1);
c) executing the firmware updating procedure for updating the working firmware (F1) after step b);
d) executing the booting procedure through the default firmware (F2) of the second memory (23) if the BMC (21) cannot read the working firmware (F1); and
e) switching a connection of the BMC (21) to connect to the first memory (22) and executing the firmware updating procedure for updating the working firmware (F1) when booting completely after step d).

8. The firmware updating method of claim 7, wherein further comprises following steps before step a):
a01) writing an updating firmware (I1) to the first memory (22) for updating the working firmware (F1) by the BMC (21); and
a02) reseting the BMC (21).

9. The firmware updating method of claim 7, wherein the control module (20) further comprises a hardware switch (24), the hardware switch (24) comprises a first reading channel (241) and a first writing channel (242) connected to the BMC (21) and the first memory (22), and comprises a second reading channel (243) and a second writing channel (244) connected to the BMC (21) and the second memory (23), wherein the BMC (21) electrically connects to a switching pin of the hardware switch (24) through a GPIO interface (3).

10. The firmware updating method of claim 9, wherein the BMC (21) in step a) reads the working firmware (F1) through the first reading channel (241); the BMC (21) in step c) writes the updating firmware (I1) to the first memory (22) for updating the working firmware (F1) through the first writing channel (242); the BMC (21) in step e) sends a control signal to the hardware switch (24) through the GPIO interface (3), and the hardware switch (24) switches the second writing channel (244) from connecting to the second memory (23) to connect to the first memory (22) according to the control signal, and the BMC (21) writes the updating firmware (I1) to the first memory (22) for re-updating the working firmware (F1) through the second writing channel (244).
